(19) United States
(12) Patent Application Publication
(10) Pub. No.: US 2011/0290329 A1
(43) Pub. Date: Dec. 1, 2011

(54) Large Area Water Redistribution Network

(76) Inventors: Regino A. GARZA, San Antonio, TX (US); Pablo V. BALDERAS, San Antonio, TX (US)

(21) Appl. No.: 12/791,601

(22) Filed: Jun. 1, 2010

(51) Int. Cl. F17D 1/08

(52) U.S. Cl. 137/2; 137/597

(57) ABSTRACT

A system and methods for the redistribution of water as a resource across large geographic distances where water deficits are matched with excess water conditions. The system utilizes a large area network of water conduits that extend between nodes, generally between water reservoirs and water usage areas. The system receives water into the network from geographic areas experiencing excess water and distributes the excess water to areas experiencing water deficits. The system includes terminal nodes having water inlet/outlet systems with metering and pumping components coupled with flow control valves. Each terminal node positioned at an existing reservoir is controlled to permit the inlet of water into the system or the discharge of water from the system. Intermediate nodes incorporate similar flow metering and pumping components as well as flow control valve components. The system is monitored and controlled through wired or wireless communication from a central station. The method provides for the establishment of normal water level ranges and the monitoring of a large number of geographic areas for excess water or water deficit conditions. The system matches excess water areas with deficit regions and coordinates the transfer of water between such regions. Excess water regions may also be coordinated with multiple normal water level regions for the distribution of excess water over a large area. A water deficit region without a direct match to a water excess region may draw from multiple normal regions.

### BACKGROUND OF THE INVENTION

1. Field of the Invention

The present invention relates generally to networks for the redistribution of consumable resources having source points and consumption points at potentially great distances from each other. The present invention relates more specifically to a nationwide network for the redistribution of water resources from areas experiencing excess water to areas experiencing water deficits.

2. Description of the Related Art

Water is undeniably an essential resource to sustain life, to carry out manufacturing, to effect transportation, and to generally maintain a standard of living associated with a developed society. Unfortunately, the quantity of water available as a resource in any given area is not entirely within control of those who utilize the resource. In many cases those who utilize water as a resource in a given geographic area are subject to changes in climatic conditions over the long term, as well as changes in weather patterns over the short term for a determination of the quantity of water as a resource that is available. In addition to suffering from water deficit conditions, geographic areas can suffer from excess water conditions. Flooding can be just as devastating as drought to a geographic region. Society's ability to control the conditions that surround flooding events and drought events is fairly limited.

It would be desirable if a system were developed that permitted the distribution or redistribution of water as a resource between geographic areas that at one point in time may be experiencing excess water conditions to remote geographic areas that at the same point in time are experiencing deficit water conditions. It would be desirable if such a network for the redistribution of water as a resource could be centrally controlled and automated such that the system could anticipate and immediately respond to conditions in geographically distant locations. Although the system that is the subject of the present invention is described in conjunction with geographic regions of the United States, it is anticipated that the principles and concepts described translate into similar systems in other countries around the world. In addition, although the system described is provided in conjunction with the United States under a single federal umbrella authority, it is anticipated that the methods and systems described could translate into international systems not dependent upon implementation by a single governmental body.

### SUMMARY OF THE INVENTION

The present invention therefore provides a system and methods for the operation of the system that allows for the redistribution of water as a resource across large geographic distances where water deficits are matched with excess water conditions in different parts of the country. The system utilizes a large area network of water conduits that extend between nodes across the nation, generally between water reservoirs such as both natural and manmade lakes, rivers, canals, etc., and water usage areas such as population centers. The system is capable of being configured to receive water into the network from geographic areas experiencing excess water as a resource to areas experiencing water deficits. The system includes terminal nodes having water inlet/outlet systems coupled with water flow metering and pumping components further coupled with flow control valve components. Each such network inlet/outlet station, or terminal node, positioned at an existing reservoir, is controlled to permit the input of water into the system or the discharge of water from the system. Intermediate nodes incorporate similar flow metering and pumping components as well as flow control valve components. The entire system is monitored or controlled either through wired communication or wireless communication from a central controller or coordination station. The system may be further monitored and controlled by way of a variety of data gathering facilities and automation direction facilities, including weather forecasting centers, state control centers, and federal inter-agency monitoring and control centers. The method of the present invention provides for the establishment of normal water level ranges and the monitoring of a large number of disparate geographic areas for excess water or water deficit conditions. The system matches excess water areas with deficit regions and coordinates the direct transfer of water between such regions. Absent a direct match, excess water regions may be coordinated with multiple normal water level regions for the coordinated distribution of excess water over a large area. In a similar manner, the existence of a water deficit region without a direct match to a water excess region would be coordinated for coverage of water resources by drawing from multiple normal regions and converging the water to the deficit region.

### BRIEF DESCRIPTION OF THE DRAWINGS

FIG. 1 is a map of the contiguous United States (absent Alaska and Hawaii) that includes the natural and manmade water reservoirs (lakes and rivers) of significant size in the United States and also reflects the overlay of the system network of the present invention.

FIG. 2 is a map of the United States showing the interstate highway system being utilized as the primary right-of-way for the establishment of the network conduits of the system of the present invention.

FIG. 3 is a schematic diagram illustrating the components associated with each of the plurality of nodes within the network system of the present invention.

FIG. 4 is a partially schematic diagram showing the structural components associated with a single network path from a water resource to a water distribution site associated with the system of the present invention.

FIG. 5 is an alternate embodiment of the system of the present invention showing control and communication by wireless means as opposed to wired means.

FIG. 6 is a high level flow chart providing the basic procedural steps associated with implementation of the method of the present invention.

### DETAILED DESCRIPTION OF THE PREFERRED EMBODIMENTS

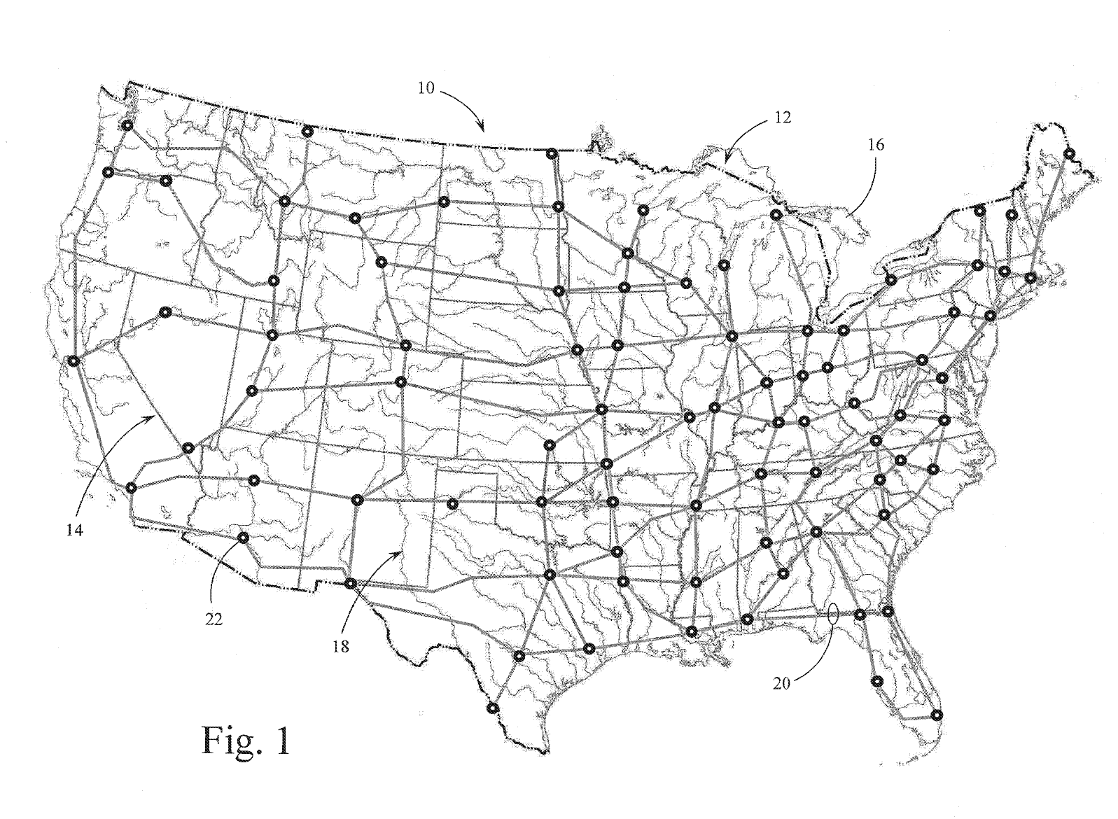

Reference is made first to FIG. 1 for a brief description of the geographic area over which the systems and methods of the present invention may be implemented. As indicated above, although the present invention is described specifically in conjunction with the geographic area of the contiguous United States, the principle and concepts associated with the system and methods could easily translate into use in other geographic regions around the world. The essential elements to the system include geographic areas where water is utilized as a resource and other geographic areas where water is naturally (or manmade) accumulated into reservoirs. FIG. 1 shows a map of the contiguous forty-eight United States 10 with the national boundary 12 shown about the perimeter of the map, and individual state boundaries 14 disclosed as solid lines throughout the geographic area. Various natural and manmade water reservoirs are disclosed in the form of lakes 16 and rivers 18. These water reservoirs are shown on the map in FIG. 1 as only those most significant in size and volume. It is understood that many medium sized reservoirs and smaller reservoirs do exist throughout the geographic region.

Overlayed onto the map of the United States 10 is a schematic representation of the system of the network of the system of the present invention. This network is shown primarily as a plurality of connecting water conduits 20 that extend between network nodes 22 both of which are described in more detail below. The placement of these conduits and network nodes is the result of balancing areas where water exists as a resource in a historically abundant amount with areas where population centers have historically developed. A feature of the United States that makes the system and method of the present invention possible relates to established pathways that extend across the country within which the conduits and nodes of the network system could be built. In general, however, the system would be established so as to provide both inlet points for excess water conditions and outlet points for deficit water conditions. These points may often be associated with population centers but may also be associated with large agricultural areas that would suffer from either an excess of water or a deficit of water.

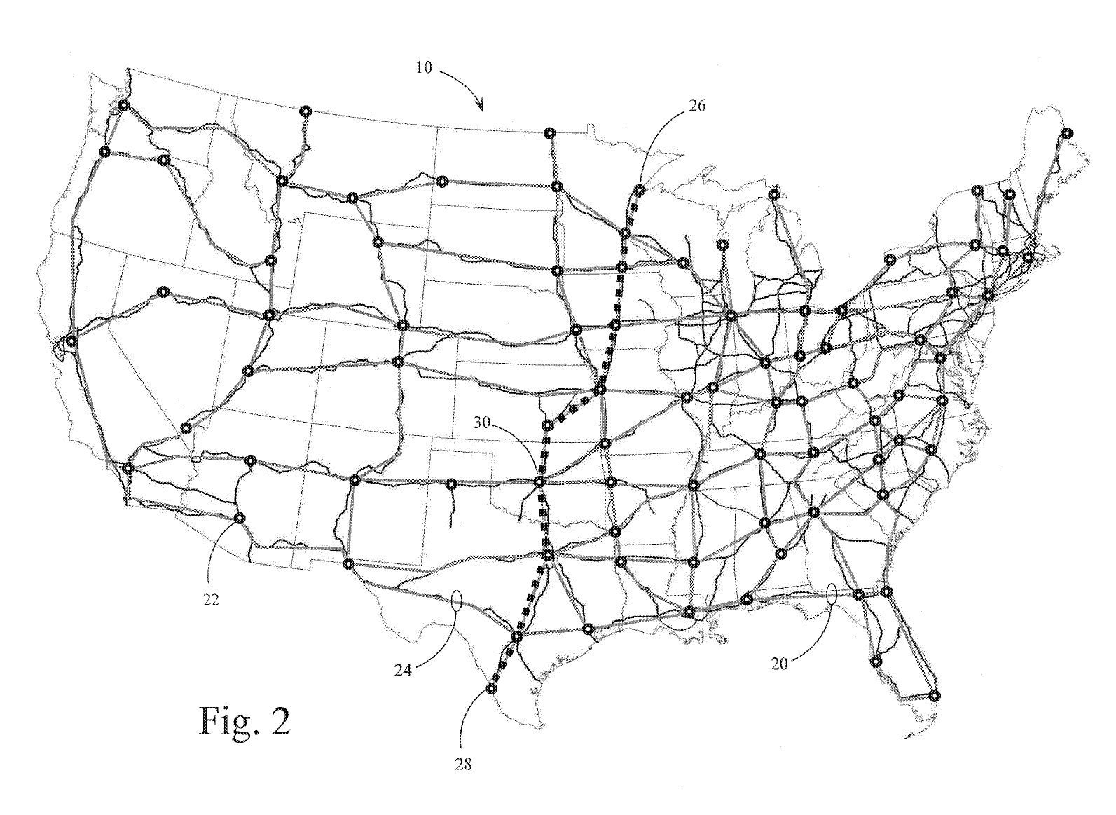

FIG. 2 represents the same map view as shown in FIG. 1 representing the contiguous forty-eight United States 10. In this representation of FIG. 2, however, the map provides a background representation of interstate highway system as it currently exists in the geographic region of the United States. Interstate highways 24 are shown in solid lines to extend between every population center of significant size within the United States. Often the interstate highway system 24 extends across unpopulated areas and as such provides an available pathway for the establishment of the conduit network required by the system of the present invention. As can be seen in FIG. 2, the routes taken by the conduit network of the system of the present invention would most efficiently follow those right-of-ways and easements already established with the interstate highway system. Recognizing that this provides perhaps the most efficient path for establishing the conduit network of the present invention, countervailing requirements such as the specific location of significant water reservoirs and the like could dictate alternate routes and/or additional pathways not associated with the interstate highway system. FIG. 2 is a representation of the most efficient implementation of the system and method of the present invention, but by no means represents the only pathways suitable for the establishment of the network.

One again in FIG. 2, the same network overlay comprising water conduits 20 and network nodes 22 are shown. Further illustrated in FIG. 2 is an example of an established partway through the network from a first node 26 having a water excess (for example) to a second node 28 having a water deficit (for example). The extension of the network path from excess node 26 to deficit node 28 is by way of a plurality of intermediate distribution nodes 30. The manner in which this network conduit is established through a plurality of network nodes is described in more detail below.

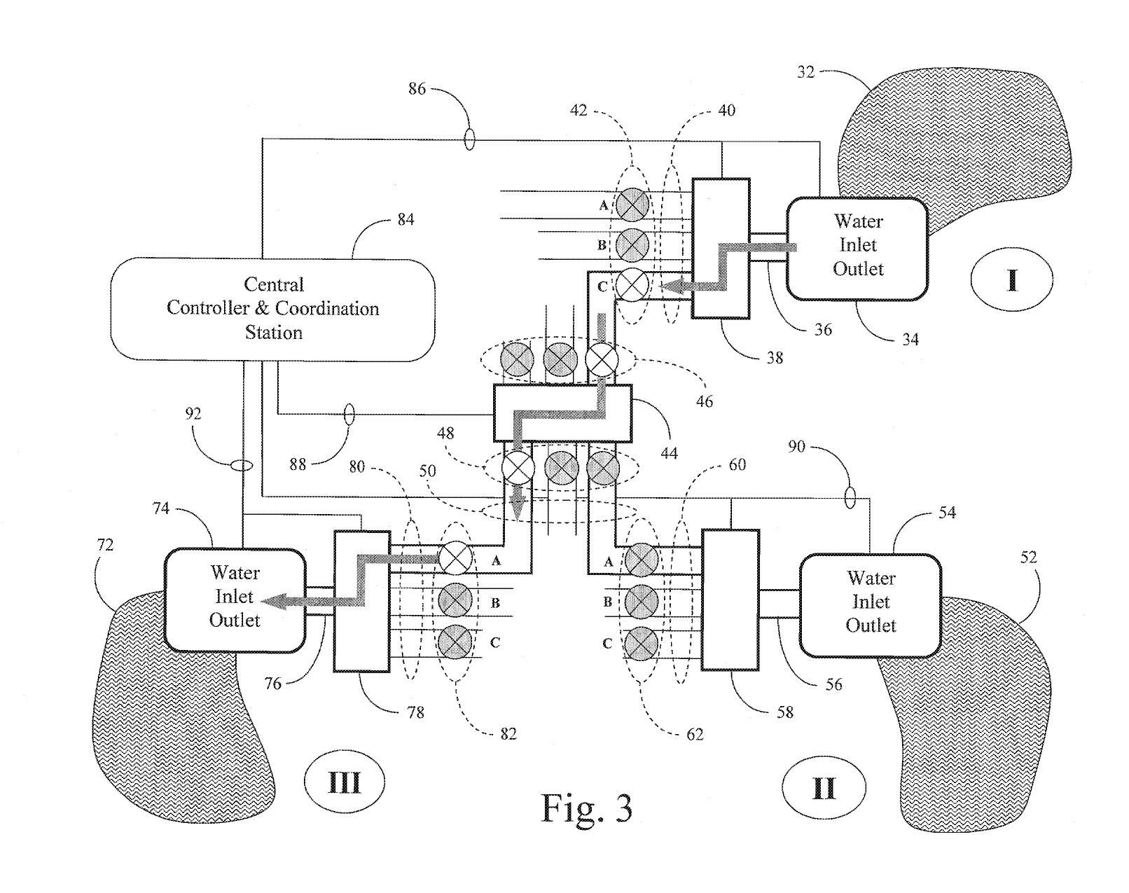

Reference is now made to FIG. 3 for a description of the basic structural components of the network system of the present invention and the manner in which they are controlled to provide a network path for the flow of water from an excess region to a deficit region. FIG. 3 provides three separate examples of inlet/outlet nodes as well as one example of an intermediate node in the distribution system of the present invention. Inlet/outlet nodes I, II, and III are represented. Inlet/outlet node I is established in conjunction with water reservoir 32. As indicated above, these water reservoirs may be natural or manmade and may include large or small lakes and rivers. In some instances, these reservoirs may include subsurface water reservoirs that behave in a manner similar to surface lakes and rivers.

Inlet/outlet node I associated with reservoir 32 comprises water inlet/outlet structure 34, which in the preferred embodiment (described in more detail below) includes an inlet/outlet conduit opening for the reception and discharge of water into or from reservoir 32. A single primary conduit 36 extends from the inlet/outlet structure 34 to flow metering and pumping components 38. This structure provides either flow metering where flow assistance is not required or provides pumping of the water from reservoir 32 where such is required to bring water into the system. Flow metering and pumping station 38 includes a manifold distribution system that directs water in to a plurality of individual distribution conduits 40. Each of the distribution conduits 40 are controlled by means of standard automatically controllable conduit valves 42. In this case, each of these valves is represented as 42A, 42B, and 42C associated with each of three distribution conduits 40 in the representation shown in FIG. 3. Those skilled in the art will recognize that there may be an number of conduits associated with a single inlet/outlet node that may vary according to the size of the reservoir associated with that node.

Similar inlet/outlet nodes are shown in conjunction with II and III in FIG. 3. Inlet/outlet node II is associated with reservoir 52 and comprises water inlet/outlet component 54 connected by way of primary conduit 56 to flow metering and pumping station 58. Flow metering and pumping station 58 is connected by way of a plurality of distribution conduit 60 through control valves 62 into the network system of the present invention.

In a similar manner, inlet/outlet node III is associated with reservoir 72 and includes water inlet/outlet structure 74 which is connected by way of primary conduit 76 to flow metering and pumping station 78. Flow metering and pumping station 78 provides a manifold of connections to distribution conduits 80, each of which incorporates a control valve 82.

Intermediate between the inlet/outlet nodes shown in FIG. 3 is a representative intermediate node that serves to selectively channel and connect a network path between an inlet location and an outlet location. Intermediate flow control system 44 incorporates a number of inlet control valves 46 on an inlet portion of the system and a number of outlet control valves 48. It is understood that this configuration for the intermediate flow control node is schematic only and that each of the conduits 50 connected to intermediate control station 44 could serve as either an inlet or an outlet to the flow of water depending upon the manner of controlled establishment of the network path. In FIG. 3 there is a representation of a flow of water from inlet/outlet node I to inlet/outlet node III by way of the connected conduits as shown.

Each of the nodes in the network system of the present invention is automatically controlled by way of signals received from central controller and coordination station 84. Signal path 86 connects the central controller and coordination station 84 to inlet/outlet node I while signal control path 88 connects the central controller and coordination station 84 to intermediate control node 44. Likewise, control signal path 90 connected central controller and coordination station 84 to inlet/outlet node II and signal path 92 connects the central controller and coordination station 84 to inlet/outlet node III.

As indicated above, the schematic representation of the network system of the present invention shown in FIG. 3 is configured to establish a network path from an inlet node I through to an outlet node III. This configuration is established under the control of central controller and coordination station 84 by directing the operation of valves 42 positioned at inlet/outlet node I. In this case, valve 42C is open to receive water from reservoir 32 through water inlet/outlet station 34 through primary conduit 36 through flow metering and pumping station 38 and into the network conduit system of the present invention. Valves 42A and 42B may be closed in order to direct the primary distribution of water from this water excess region (associated with inlet/outlet I) into the system in the geographic direction where it is required. Intermediate flow control node 44 is representative of one of a plurality of such intermediate nodes that likewise are under the automated control of central controller and coordination station 84. In this manner, the appropriate valve 46 is opened to allow the flow of water into the intermediate station to an outlet conduit 50 by way of control valve 48. In this manner, the flow of water is directed through intermediate node 44 into a specific distribution conduit within the network. In this representative example, the flow of water is directed towards an inlet/outlet III which in this case is experiencing a water deficit. Water flows from the intermediate node 44 to the inlet/outlet node III by way of open valve 82A through conduit 80A into flow metering and pumping station 78. Water is then directed to flow from flow metering and pumping station 78 through primary conduit 76 into the water inlet/outlet structure 74 associated with reservoir 72. It is anticipated that at this point in the network system the flow of water would be directed into reservoir 72 which is experiencing a water deficit and therefore may require the assistance of pumping components associated with flow metering and pumping station 78 as well as various intermediate flow metering and pumping stations within the network associated with both intermediate and end nodes in the system.

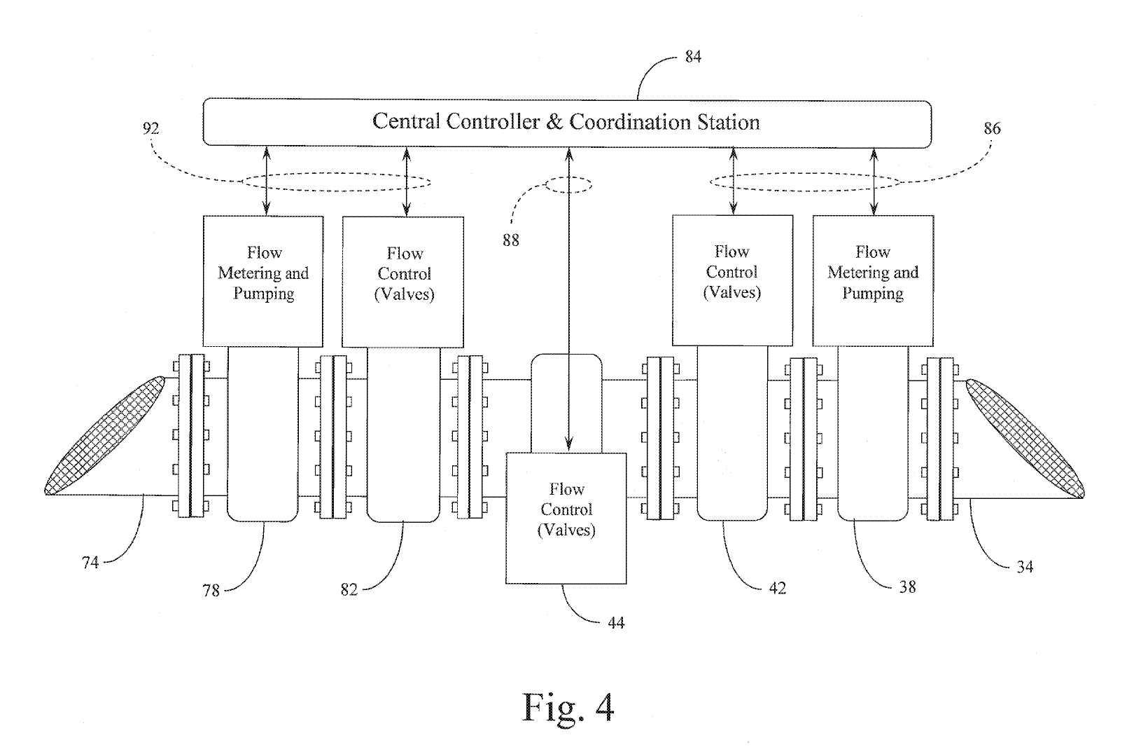

Reference is now made to FIG. 4 for a more detailed description of the structural components associated with the conduits and nodes of the system of the present invention. FIG. 4 is a partially schematic representation of the pathway established and described above in conjunction with FIG. 3 representing the flow of water from a region experiencing water excess to a region experiencing a water deficit. In the diagram shown in FIG. 4 the flow of water would be occurring from right to left through the conduit system shown. Once again, the conduit system disclosed is a schematic representation of the system established by way of automatic control governed by central controlling and coordinating station 84. In the preferred embodiment of the present invention, the primary conduits associated with inlet/outlet components 34 and 74 would be constructed of pipe lines as large as twelve feet or more in diameter. The dimensions of such inlet/outlet points in the system would be dictated by the size of the reservoirs with which they are associated. In the preferred embodiment, link lines between nodes in the system may preferably be constructed of nine foot diameter conduits, preferably buried six foot below ground level, although extending above the ground in locations where the terrain and geography require the same. The node components in the network system in the present invention would generally be established with access points above ground, although many of the valves themselves may be positioned beneath the ground's surface at the location where the distribution conduits are buried.

In the example provided above, water may be brought into the system from an excess water region by way of inlet/outlet component 34 which directs a flow of water (either under natural pressure or by pumping) into flow metering and pumping station 38. Adjacent to flow metering and pumping station 38 are positioned flow control valves 42 associated with each of the plurality of distribution conduits that converge at this particular inlet/outlet node. Both the flow metering and pumping station 38 as well as the flow control valves 42 are under the direct signal coordination control of central station 84 by way of communication signal lines 86.

As indicated above, the flow from the initial water inlet region is directed by way of one or more intermediate nodes in the system, each of which is configured as shown in FIG. 4 with flow control valves 42 under automated signal control from central station 84 by way of signal lines 88. The single intermediate flow control station 44 shown in FIG. 4 is representative of what would typically be a large number of intermediate stations, each of which appropriately directs and sometimes assists with the flow of water between the two end points in the network system.

The flow of water then proceeds to the node within the system associated with the water deficit region. In this example, water is received into the inlet/outlet node by way of flow control valves 82 structured and controlled as described above in conjunction with FIG. 3. These flow control valves receive water by way of the distribution conduits that converge into flow metering and pumping station 78 associated with the deficit region node. Here again, each of these two components within the system are under the direct control of central station 84 by way of signal communication lines 92. Finally, water is directed out from inlet/outlet structure 74 into the reservoir associated with the water deficit region.

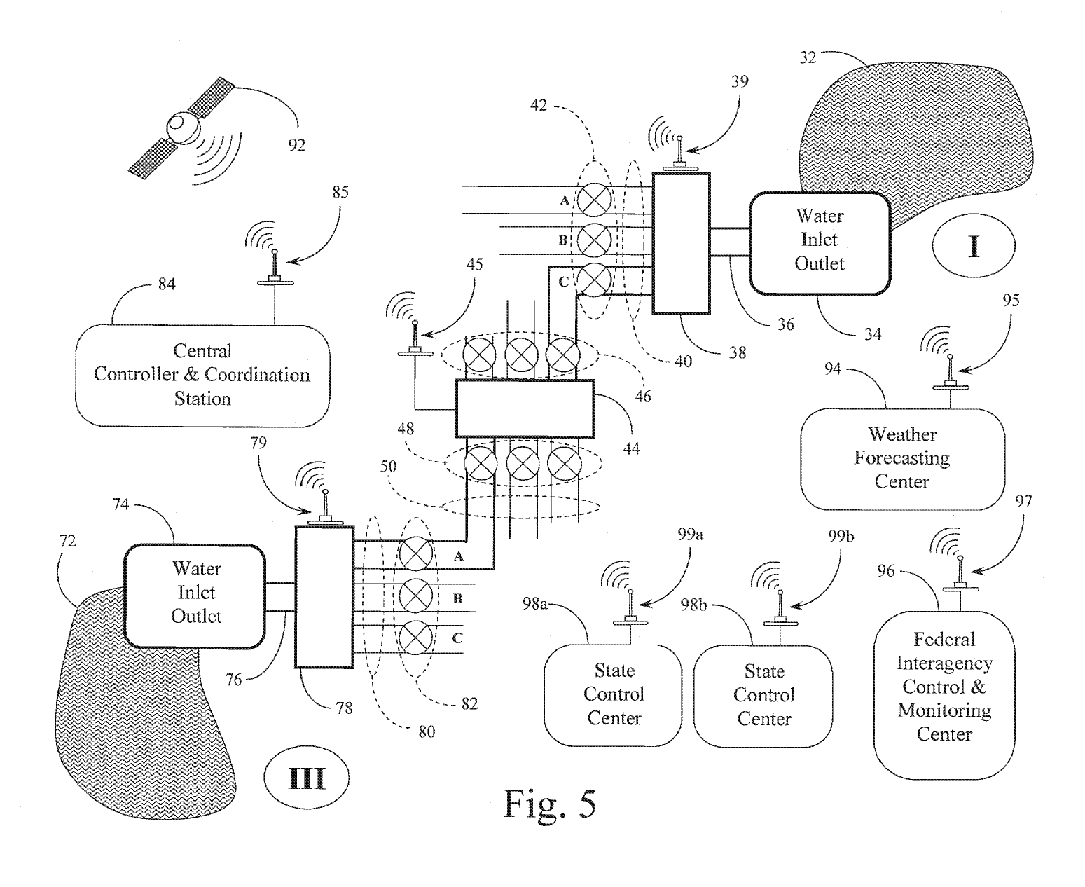

FIG. 5 represents an alternate embodiment of the present invention whereby control communication across the network system is established wirelessly as opposed to the wired communication shown in FIG. 3. The same inlet/outlet path established and described between inlet/outlet node I and inlet/outlet node III is similarly established by way of the wireless signal communication control of each of the various components described above. In this instance, wireless communication is established between central controller and coordination station 84 by way of transceiver 85 preferably directed through communication satellite 92. In this manner, each of the various remotely located components in the network system of the present invention may easily direct signal transmission and reception to the coordinated satellite communication system. Flow metering and pumping station 38, for example, associated with inlet node I receives control signals from central station 84 by way of communications transceiver 85 through satellite 92 and down through communication transceiver 39 associated with flow metering and pumping station 38. The intermediate components, and the remaining end components of the system, likewise incorporate communications transceivers 45 and 79 for the automated control of the various mechanical components (primarily valves) associated with the network system. Flow data is likewise communicated through the signal communication system shown often back from the remote flow locations by satellite 92 to the central station 84.

As indicated above, the preferred embodiment of the present invention incorporates additional monitoring and control centers that allow for ancillary or supplemental data collection and control functions within the system. These additional centers may preferably include a weather forecasting center 94 which provides data by way of signal transceiver 95 into the communication system of the network as well as federal interagency control of monitoring center 96 and state control centers 98A, 98B, etc. Each of these centers has a wireless communications capability that allows it to provide data to, and in some instances interject control over, the network system of the present invention. Various protocols associated with the collection of data and the control of the system are anticipated.

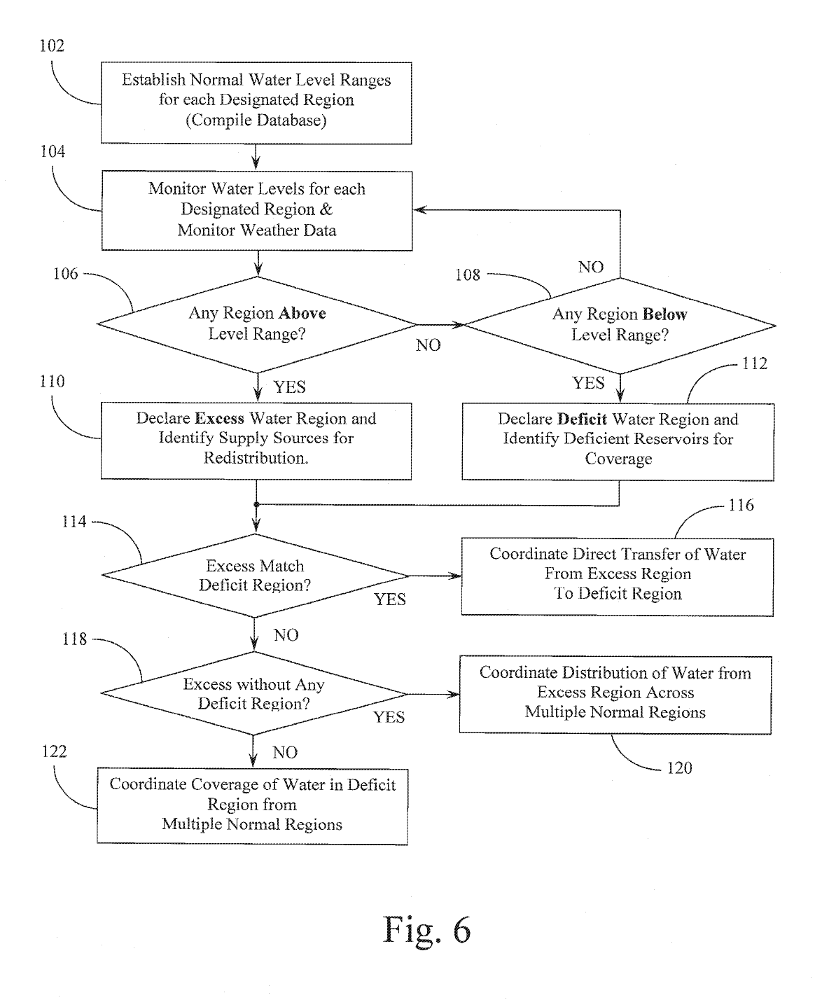

Reference is finally made to FIG. 6 for a description of the overall methodology associated with the operation of the system of the present invention. Although much more complex protocols would be established for specific day-to-day operation of the components within the system, the methodology disclosed in FIG. 6 provides an overview of the data collection and automated coordination of the various system components on a day-to-day basis. Initially in the method of the present invention shown at Step 102, it is necessary to establish the normal water level ranges for each of the designated regions within the system. This process of compiling a database of normal levels is essential to the automated operation of the system. While such a database could be revised on a continuous basis based upon ongoing historical conditions, it is necessary to initially establish a base line for the control of the pathways in the network of the system. Step 104 provides the ongoing monitoring functionality within the system wherein water levels within each of the designated regions are monitored and characterized for comparison to historical data. This monitoring at Step 104 would occur in conjunction with existing reservoir levels and in many cases would utilize existing flood gauges and water level measuring equipment. In addition to monitoring existing levels and conditions, various weather data would preferably be included in the data collection stage of the method so as to anticipate rapid changes in the water level conditions. This collected data is then examined automatically, and at Step 106 an initial determination is made as to whether any region is above the normal water level range for that region. If not, the process proceeds to Step 108 where a determination is made if any region is below the normal water level range for that region. If not, the process returns to Step 104 where the monitoring functionality continues. If a region is determined to be above its normal water level range at Step 106, the process proceeds to Step 110 wherein that region is declared an excess water region and identified as a supply source for redistribution within the network. In a similar manner, if at Step 108 a region is determined to be below its normal water level range, then at Step 112 it is declared to be a deficit water region and is identified as having reservoirs deficient and suitable for reception of coverage for water from the network. In either case, the process proceeds at Step 114 to determine if there is a match between a declared excess water region and a declared deficit water region. If this is the case, then at Step 116 the system coordinates the direct transfer of water from the identified excess water region to the matched deficit region. This step in the method would, for example, connect and carry out the distribution of water in the example shown in FIG. 3.

If a direct match is not identified at Step 114 between an excess region and a deficit region, a determination is made at Step 118 whether there is a declared excess water region without a matched declared water deficit region. If this is the case, then the process proceeds at Step 120 to coordinate the distribution of water from the excess the region (i.e., a region where flooding may be occurring) across multiple normal regions in order to spread out the excess water from the declared excess water region. In other words, the system at Step 120 would be functioning primarily as a means for reducing flood levels in an excess water region and redistributing those flood water levels to a variety of geographic regions that may not specifically require additional water but are capable of handling excess water and spreading it out as a resource.

If at Step 118 it is determined that there is not an excess region without a deficit region, then the conclusion is only that there is a deficit region without a specific match to an excess region. In this case, the system still coordinates the coverage of water to the deficit region at Step 122 but does so from multiple normal regions as opposed to having matched the deficit region with an excess region. In this manner, even when no region of the country is experiencing an excess condition, those regions experiencing deficit conditions may still draw upon water from regions having normal water levels in a manner of alleviating the deficit condition without dramatically effecting or reducing the water levels in any single region.

Clearly, the preference in the system of the present invention is to establish a direct connection between a region that has been declared to contain excess water as a resource (i.e., a region where flooding is occurring) to a region that is experiencing a water deficit (i.e., drought conditions). Where such matches can occur, the system operates most efficiently. Based on historical data, it is anticipated that such direct matches can generally be made across a geographic region as large as the United States. It is not unusual for flooding conditions in one area of the country to occur simultaneously with drought conditions in other areas of the country. The system of the present invention would therefore provide a direct means for redistributing the excess water in a region that is experiencing flooding into a regions that is experiencing drought conditions.

Absent this direct flow, however, the system of the present invention is configured to accommodate excess in one region (i.e., flooding) into a large number of regions that may only be experiencing normal water levels. In general, it is anticipated that each region experiencing normal water level range could receive a modest amount of excess water without significant detrimental effects on the region. Again, with a geographic area as large as the contiguous United States it is possible to take a large amount of excess water from a region experiencing flooding and distribute it over an extremely wide area in small amounts such that any damage caused by the excess water is significantly reduced. In a similar manner, even where no region in the country may be experiencing flooding at a given point in time, it is possible to collect small amounts of water from a wide area or a large number of normal water level regions and collect and converge such water into a single area experiencing significant water deficit (drought).

Although the present invention is described with a preferred embodiment, those skilled in the art will recognize certain modifications to both the components within the system and the methods associated with its operation that fall within the spirit and scope of the invention.

We claim:

1. A system for the redistribution of water as a resource over large geographic distances, the system comprising:
a network of water conduits extending between a plurality of terminal and intermediate nodes, the network serving to connect a plurality of water resource areas with a plurality of water usage areas;
a plurality of water inlet/outlet stations positioned at the terminal nodes on the network of water conduits, the inlet/outlet stations comprising valves for allowing or preventing the movement of water into or out from the network of water conduits;
a plurality of transit stations positioned at the intermediate nodes on the network of water conduits, the transit stations comprising valves for allowing or preventing the movement of water through the network of water conduits; and
a monitoring and control system for remotely directing the opening and closing of the plurality of valves in the network of water conduits;
wherein excess water at a water resource area may be directed to flow through the network of water conduits to a water usage area having a water deficit.

2. A method for redistributing water as a resource across large geographic distances, the method comprising the steps of:
providing a large area network of water conduits extending between nodes, the nodes comprising terminal nodes and intermediate nodes having valves for controlling the flow of water through the network of water conduits;
defining a normal water level range for a geographic region around each terminal node;
monitoring an availability of water as a resource at the terminal nodes within the network of water conduits;
declaring an excess water region for any geographic region around a terminal node above its normal water level range and identifying supply reservoirs within that geographic region for a redistribution of water;
declaring a deficit water region for any geographic region around a terminal node below its normal water level range and identifying deficient reservoirs within that geographic region for a redistribution of water;
matching an excess water region with a deficit water region and coordinating and controlling a redistribution of water from the matched excess water region to the matched deficit water region through the water conduit network;
identifying an excess water region without a matching deficit water region and coordinating a redistribution of water from the excess water region across multiple normal water regions; and
identifying a deficit water region without a matching excess region and coordinating a redistribution of water from multiple normal water regions to the deficit water region.
